(19) United States
(12) Patent Application Publication
(10) Pub. No.: US 2017/0056290 A1
(43) Pub. Date: Mar. 2, 2017

(54) Pharmaceutical Cold Box with Central Ice or Cold Pack Chamber

(71) Applicant: Massachusetts Institute of Technology, Cambridge, MA (US)

(72) Inventors: Prithiviraj Sundararaman, San Jose, CA (US); Daniel D. Frey, Natick, MA (US)

(21) Appl. No.: 15/223,775

(22) Filed: Jul. 29, 2016

Related U.S. Application Data
(60) Provisional application No. 62/210,500, filed on Aug. 27, 2015.

(51) Int. Cl. A61J 1/16; B65D 81/38

(52) U.S. Cl. CPC A61J 1/165; B65D 81/3813

(57) ABSTRACT

Cold box. The cold box includes an enclosure comprising insulating walls having a first selected R value per surface area defining an interior space. A cold pack is located in a central region of the interior space and insulating material having a second R value per surface area is adjacent the cold pack forming a cold chamber within the interior space for receiving a substance between the insulating material and the insulating walls. The ratio of the first selected R value per surface area to the second selected R value per surface area is chosen to maintain temperature in the cold chamber within a selected range.

This application claims priority to provisional application No. 62/210,500 filed on 27 Aug. 2015, the contents of which are incorporated herein by reference.

“This invention was made with Government support under Contract No. AID-OAA-A-12-00095 awarded by the U.S. Agency for International Development. The Government has certain rights in the invention.”

This invention relates to cold boxes especially for transporting pharmaceuticals such as vaccines within a safe temperature range.

Vaccines among other pharmaceutical substances must be kept under strict temperature control. Maintaining cold chain practices requires a great deal of infrastructure and training for effective coverage. Therefore, technologies used for maintaining the cold chain must be high performing, cost effective, and easy to use.

Often there are negative effects that can be incurred when pharmaceutical substances are exposed to temperatures above or below a recommended range. For example, vaccines lose potency faster when exposed to temperatures above or below the temperature range of 2 to 8° C. A study conducted in 2007 in various countries including hot not limited to: USA, Australia, Indonesia, and Kenya showed that up to 100% of vaccines had been exposed to temperatures below the recommended range at some point in the cold chain, either daring storage or transport².

The design of existing technology surrounds the substance to be cooled with ice or cold packs. In other words, the vaccines and other pharmaceutical substances are placed in the innermost part of a cold box and the ice or cold packs are placed in between the substance and the insulating wall of the cold box. FIG. 1 shows a side view cross section of a typical prior art cold box using this existing protocol. In FIG. 1, a cold box 10 includes insulated walls 12 forming an enclosure creating a cold chamber 14. Note that in this prior art design the ice pack or cold pack 16 is at the periphery of the enclosure. A pharmaceutical such as a vaccine (not shown) will be contained in the cold chamber 14 within the cold box 10. It is believed that this prior art configuration is more harmful in terms of temperature control and is the reason for suboptimal temperatures in the cold chain. The graph on the right side of FIG. 1 shows the temperature distribution in the cold box at steady state as a function of position. It is clear that at steady state the cold chamber 14, and the vaccines, are below the recommended temperature range.

As shown in FIG. 1 the contents of the cold box 10 reach the steady state temperature of the ice or cold packs 16. Newer protocols suggest the use of preconditioned ice or cold packs and sometimes cool water packs as an alternative to conventional ice or cold packs. There are, however, two drawbacks to these newer protocols. The main issue is that the effectiveness of these protocols can only be realized through effective training of personnel who use these cold boxes. This has been a major obstacle in current cold chain practices which only suggests that a change in methodology will be difficult and slow to be adopted by users. Additionally, from a technical standpoint the preconditioning of ice or cold packs and use of cool water packs wastes energy from these coolants. Energy is released in the process of melting ice which can be harnessed to cool vaccines and other substances. In developing areas where energy is already at a premium this practice is not sustainable.

Another method being pursued to prevent or mitigate the risk of exposure to temperature below the recommended range has been designed and is being disseminated that suggests use of materials such as bubble wrap as a barrier between ice and the pharmaceutical substances. Additionally, newer designs of coolers incorporate a solid barrier typically made of the same insulation material (usually polyurethane) as the exterior facing insulation in an attempt to isolate the ice or cold packs (shown in FIG. 2). However, further analysis of these designs shows that they are not effective. The issue of temperature exposure below the recommended temperature range is a consequence of the melting point of the ice or cold packs as well as the position of the ice or cold packs being placed in between the vaccines and the ambient air.

It is assumed that the same material is used for insulation from the ambient air as well as between the vaccine chamber and ice or cold packs, as shown in FIG. 2, and that the rate of beat transfer is constant. Regardless of the ratio of thicknesses of insulation material (d2/d1) the settling temperature of the vaccines will be 0°Celsius which is outside of the recommended temperature range and will be damaging to the vaccines.

An object of this invention, therefore, is to maintain the potency and integrity of vaccines and other pharmaceutical substances through effective temperature control within the recommended ranges. Specifically, the invention achieves this object without harmful exposure

to extreme temperatures, especially at or below the substances' freezing point, which occurs with the use of existing technology.

### SUMMARY OF THE INVENTION

The cold box according to the invention includes an enclosure defining an interior space comprising insulating walls having a first selected R value per surface area. A cold pack is located in a central region of the interior space and insulating material having a second R value per surface area is adjacent the cold pack forming a cold chamber within the interior space for receiving a substance between the insulating material and the insulating walls. The ratio of the first selected R value per surface area to the second selected R value per surface area is chosen to maintain temperature is the cold chamber within a selected range.

When the insulating walls and insulating material are made of the same material, the R values per surface area are proportional to the thickness of the respective structures. In a preferred embodiment, the selected temperature range is approximately 2° to 8° C. In some embodiments, the ratio of first selected R value per surface area to the second selected R value per surface area is in the approximate range of 3 to 10.

### BRIEF DESCRIPTION OF THE DRAWING

FIG. 1 is a cross-sectional view of a prior art cold box along with a graph of temperature against position within the cold box.

FIG. 2 is a cross-sectional view of another prior art cold box.

FIG. 3 is a cross-sectional side view of an embodiment of the invention disclosed herein along with a graph of temperature against position.

FIG. 4 is a cross-sectional view of an embodiment disclosed herein with an ice barrier for analysis.

FIG. 5 is a graph of vaccine temperature against thickness ratio d2/d1 for the cold box of the invention.

FIG. 6 is a top view of the embodiment of the invention shown in FIG. 3.

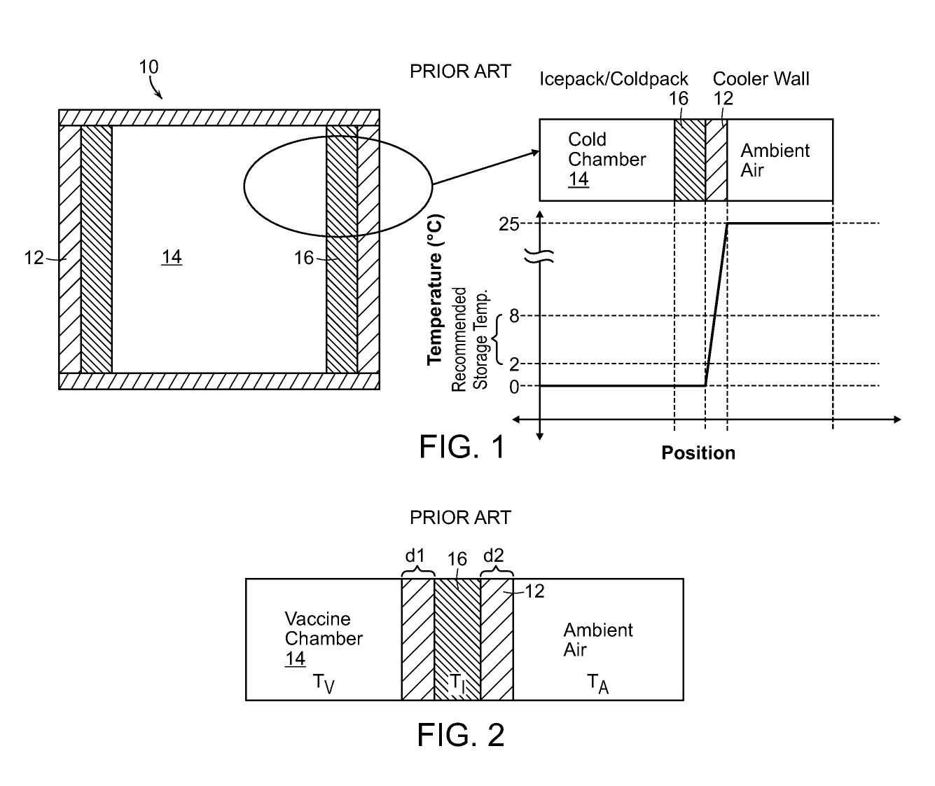

### DESCRIPTION OF THE PREFERRED EMBODIMENT

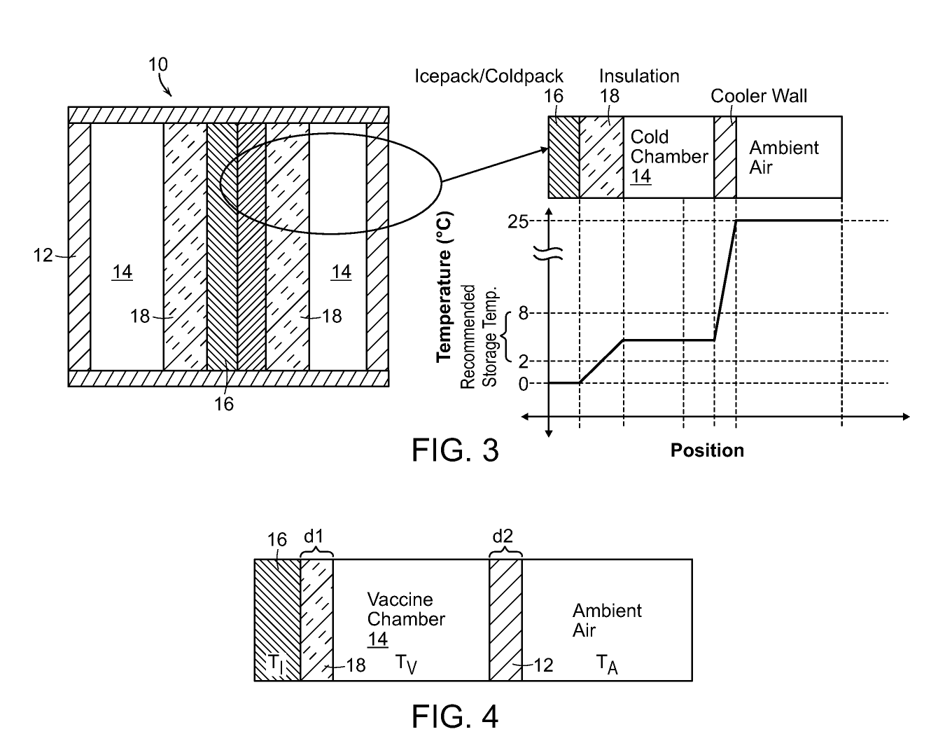

In the present invention as shown in FIG. 3, the pharmaceutical substances surround the ice or cold packs 16, reducing the risk of exposure to temperatures below the recommended range. Rather than placing the ice or cold packs 16 between the substance and the insulating wall 12, the substances are placed in between the ice or cold packs 16 and the insulating wall 12. Additionally, an insulation barrier 18 is placed between the ice or cold packs and the substances to further protect from freezing through direct conduction.

Analysis was conducted by applying the model with the same assumptions as used for the existing cold box case, but changing the configuration to reflect the parameters of the invention (shown in FIG. 4). The results of the analysis show the temperature of the vaccines as a function of the ambient temperature and ratio of thicknesses of insulations. Insulation is characterized by its R-number per surface area as well understood by those of skill in the art. For the same material, R value per surface area scales with material thickness.

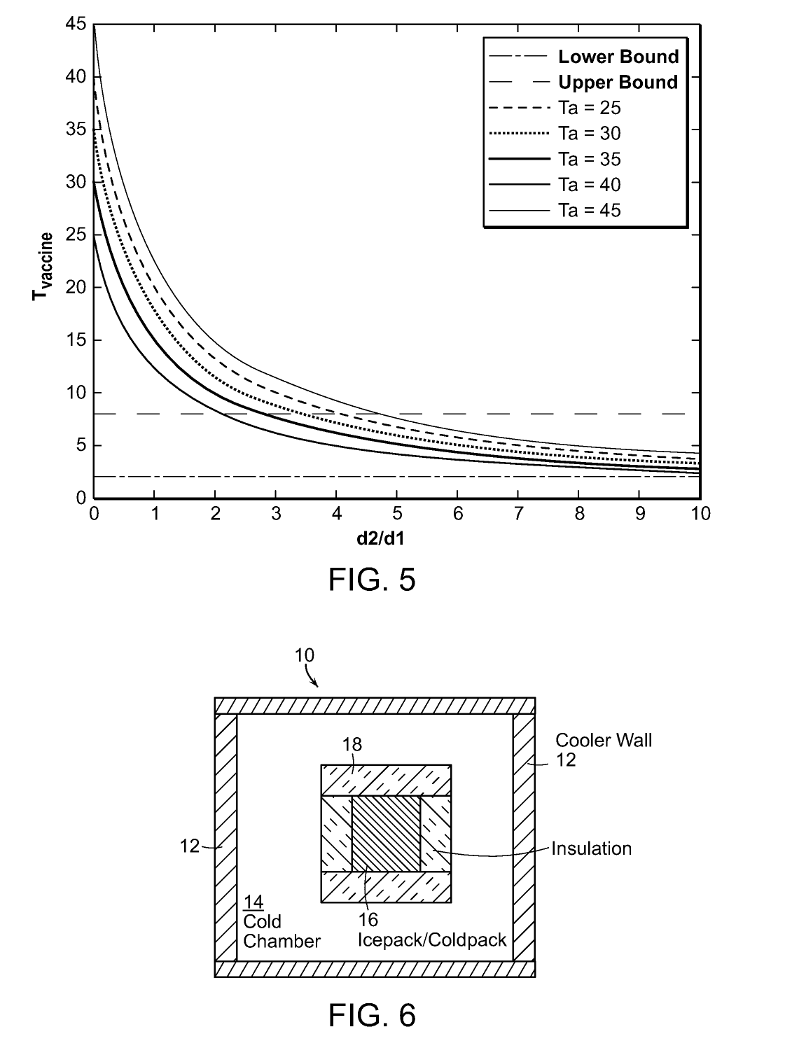

As shown in FIG. 5 it is possible to hold the temperature of the vaccines within the recommended range by using a reasonable ratio of thicknesses of the external facing insulation and the ice barrier.

FIG. 6 is a top view of an embodiment of the invention disclosed herein showing the central location of the ice pack 16 surrounded by insulation 18 to provide a cold chamber 14.

The main goal of this invention is to prevent incidences of freezing of substances in the cooler by reconfiguring the location of the coolant material. Another improvement that may be a consequence of this design is the reduction of coolant material required. Since the ice or cold packs are not in direct contact with the exterior facing walls, less heat will be communicated directly to these ice or cold packs. Tins means that the infrastructural burdens of producing ice are lessened since a smaller quantity is needed. In addition, this saved space could translate into more space available for the transport of vaccines, thus reducing the overall cost of transportation per dose.

The superscript numbers in this specification refer to the references listed herein. The contents of these references are incorporated herein by reference.

It is recognized that modifications and variations of the present invention will be apparent to those of ordinary skill in the art and it is intended that all such modifications and variations be included within the scope of the appended claims.

What is claimed is:

1. Cold box comprising:
an enclosure comprising insulating walls having a first selected R value per surface area defining an interior space;
a cold pack located in a central region of the interior space; and
insulating material having a second R value per surface area adjacent to the cold pack forming a cold chamber within the interior space for receiving a substance between the insulating material and the insulating walls;
wherein the ratio of the first selected R value per surface area to the second selected R value per surface area is chosen to maintain temperature in the cold chamber within a selected range.

2. The cold box of claim 1 wherein the insulating walls and insulating material are made of the same material and R values per surface area are proportional to thicknesses of the respective structures.

3. The cold box of claim 1 wherein the selected temperature range is approximately 2° to 8°C.

4. The cold box of claim 1 wherein the ratio of the first selected R value per surface area to the second selected R value per surface area is in the approximate range of 3 to 10.
